(19) United States
(12) Patent Application Publication
(10) Pub. No.: US 2026/0146305 A1
(43) Pub. Date: May 28, 2026

(54) Nanoparticle Dispersion Strengthened Copper Alloy and Preparation Method and Use Thereof

(71) Applicant: Central South University, Hunan (CN)

(72) Inventors: Zhou Li, Hunan (CN); Wenting Qiu, Hunan (CN); Zhu Xiao, Hunan (CN)

(21) Appl. No.: 18/729,247

(22) PCT Filed: May 29, 2023
(86) PCT No.: PCT/CN2023/096866

§ 371 Date: Jul. 16, 2024

(30) Foreign Application Priority Data
Jan. 16, 2023 (CN) 202310068183.X

(51) Int. Cl. C22C 1/059; C22C 1/057; C22C 32/00

(52) U.S. Cl. CPC C22C 1/059; C22C 1/057; C22C 32/0021

(57) ABSTRACT

The present disclosure relates to a nanoparticle dispersion strengthened copper alloy and a preparation method and use thereof. The method includes the steps of: S1) preparing Cu—Al₂O₃ dispersed copper powder from Cu—Al alloy powder by internal oxidation and reduction; and S2) mixing the Cu—Al₂O₃ dispersed copper powder prepared in S1 with Cr powder to obtain a composite powder, and subjecting the composite powder to press forming, hot press sintering, sheath moulding, and then aging treatment, where the hot press sintering is conducted at a temperature of 900° C. to 1070° C. and a pressure of 40 MPa to 80 MPa for 2 hours to 8 hours.

### CROSS-REFERENCE TO RELATED APPLICATION

This application is the United States national phase of International Patent Application No. PCT/CN2023/096866, filed May 29, 2023, and claims priority to Chinese Patent Application No. 202310068183.X, filed Jan. 16, 2023, the disclosures of which are hereby incorporated by reference in their entireties.

### BACKGROUND

### 1. Technical Field

The present disclosure relates to the field of alloy materials, and in particular to a nanoparticle dispersion strengthened copper alloy and a preparation method and use thereof.

### 2. Technical Considerations

Al₂O₃ nanoparticle dispersion strengthened copper alloy is a novel structural and functional material with excellent comprehensive physical and mechanical properties, which possesses high strength, high electrical conductivity, and good resistance to high temperature softening. The most effective industrial method currently used to prepare Al₂O₃ nanoparticle dispersion strengthened copper alloy is mostly the internal oxidation technique. The specific process of internal oxidation is as follows: firstly, a Cu—Al alloy with a specific composition is melted and then atomized into powder using gas or water atomization; the resulting alloy powder is then mixed with a suitable amount of oxidizing agent and heated in an inert gas atmosphere within a sealed container for internal oxidation, during which the Al that is dissolved within the Cu crystal lattice of the alloy is preferentially oxidized by the oxygen that diffuses in from the surface, resulting in the formation of dispersed Al₂O₃ particles; subsequently, the composite powder is reduced in a hydrogen atmosphere to remove any residual oxygen, forming the final Cu—Al₂O₃ dispersed copper powder; and finally, the Cu—Al₂O₃ powder is subjected to press forming and then to sheath moulding and sintering, and extruded into rods. During the internal oxidation process, if the Al cannot be fully internally oxidized, both the strength and electrical conductivity of the alloy will be affected. The completeness of internal oxidation is related to the Al content in the alloy before internal oxidation, that is, higher Al content results in lower completeness of internal oxidation, leading to a larger difference between the actual electrical conductivity and the theoretical electrical conductivity. For example, when using Cu—Al powder with an Al content of 0.6 wt % to prepare dispersed copper, the theoretical electrical conductivity can reach 90% IACS (International Annealed Copper Standard). However, the electrical conductivity of the dispersed copper produced in current industrial production with this composition often falls below 80% IACS. Moreover, as the Al content increases, while the concentration of dispersed particles increases, coarse Al₂O₃ is also more likely to form at the grain boundaries, which significantly degrades the processability of the alloy. The patent CN 109207766 A discloses a process for preparing a Cu—Al₂O₃ nanoparticle dispersed copper alloy with controllable microstructure and high aluminum content. This process involves high-energy ball milling of the internally oxidized powder to reduce the concentration of residual aluminum by oxidizing it during the milling process, thereby improving the electrical conductivity of the alloy. However, high-energy ball milling may easily lead to the introduction of impurities and significantly increase the manufacturing costs.

In view of this, developing a new method for preparing a nanoparticle dispersion strengthened copper alloy with both high electrical conductivity and high plasticity is of great significance.

### SUMMARY

The present disclosure aims to solve at least one of the above technical problems existing in the prior art. In view of this, the present disclosure provides a method for preparing a nanoparticle dispersion strengthened copper alloy with low residual aluminum, which can overcome the problem in the prior art of low electrical conductivity and plasticity of the Cu—Al₂O₃ nanoparticle dispersion copper alloy when its residual aluminum content is high.

The present disclosure also provides the nanoparticle dispersion strengthened copper alloy prepared by the above method.

The present disclosure further provides use of the above-described alloy.

According to a non-limiting aspect of the present disclosure, there is provided a method for preparing a nanoparticle dispersion strengthened copper alloy, including the steps of:
S1: preparing Cu—Al₂O₃ dispersed copper powder from Cu—Al alloy powder by internal oxidation and reduction; and
S2: mixing the Cu—Al₂O₃ dispersed copper powder prepared in step S1 with Cr powder to obtain a composite powder, and subjecting the composite powder to press forming, hot press sintering, sheath moulding, hot extrusion, solid solution treatment, cold deformation, and then aging treatment;
wherein the hot press sintering is conducted at a temperature of 900° C. to 1070° C. and a pressure of 40 MPa to 80 MPa for 2 hours to 8 hours.

According to a non-limiting embodiment of the present disclosure, at least the following beneficial effects are achieved. According to the technical scheme of the present disclosure, mixing the prepared Cu—Al₂O₃ dispersed copper powder with Cr powder and subjecting the mixture to high-temperature sintering promotes the formation of a solid solution between the residual Al in the dispersed copper matrix and Cr, and subsequent aging treatment allows for the complete precipitation of this solid solution from the matrix, effectively reducing the residual Al concentration in the dispersed copper. This significantly improves the electrical conductivity of the dispersed copper alloy. Furthermore, the solid solution treatment significantly enhances the plasticity of the dispersed copper, making it more readily machinable. By adding Cr powder during the high-temperature sintering of Cu—Al₂O₃ dispersed copper powder, the negative impact of residual aluminum on electrical conductivity can be mitigated. At high temperatures, Cr has a solid solubility of 0.8 wt % in Cu. Therefore, during the high-temperature hot press sintering process, Cr from the Cr powder can diffuse into the Cu matrix. Moreover, Al has a higher solid solubility in Cr at high temperatures compared to in Cu. This leads to the residual Al in the dispersed copper powder readily diffusing into Cr to form a Cr—Al solid solution. As the temperature decreases, the solid solubility of Cr in Cu drops significantly, reaching only 0.03% at room temperature. Consequently, the Cr dissolved in the matrix can be fully precipitated out through aging treatment. However, Al still exhibits a high solid solubility in Cr at room temperature and remains dissolved in Cr. This effectively reduces the residual Al content in the dispersed copper, resulting in a significant improvement in the electrical conductivity of the dispersed copper. Compared to conventional dispersed copper alloys, the dispersed copper alloy sintered with Cr powder exhibits a 3% to 20% IACS increase in electrical conductivity. Furthermore, after solid solution and aging treatment, the dispersed copper alloy with added Cr powder shows a significant enhancement in plasticity, with an elongation increase of 3% to 10% compared to dispersed copper alloys without Cr powder addition.

In a non-limiting embodiment of the present disclosure, the main components of the nanoparticle dispersion strengthened copper alloy are copper, Al₂O₃ and Cr, where the nanoparticle dispersion strengthened copper alloy contains Al₂O₃ in the range of 0.23 vol % to 4.5 vol % and Cr in the range of 0.05 wt % to 5 wt %. Other components in the copper alloy are inevitable impurities.

In some non-limiting embodiments of the present disclosure, the internal oxidation includes the steps of: melting Al and Cu at 1200° C. to 1230° C. to prepare the alloy powder by atomization using a protective gas, and then mixing the resulting alloy powder with an oxidizing agent for oxidation reaction, where the oxidizing agent is at least one of Cu₂O or CuO.

In some non-limiting embodiments of the present disclosure, the oxidizing agent and the alloy powder are mixed at a ratio where the ratio of the oxygen in the oxidizing agent to the aluminum in the powder, O:Al, ranges from 0.9:1 to 1.8:1.

In some non-limiting embodiments of the present disclosure, the mass ratio of the oxidizing agent to the alloy powder ranges from 0.005:1 to 10:1.

In some embodiments of the present disclosure, the protective gas is nitrogen or inert gas; and optionally, the inert gas is argon.

In some non-limiting embodiments of the present disclosure, the internal oxidation further includes the step of sieving the alloy powder obtained by atomization to sieve out the alloy powder with a particle size of less than 40 mesh.

In some non-limiting embodiments of the present disclosure, the internal oxidation is conducted at a temperature ranging from 880° C. to 920° C. for 1 hour to 8 hours.

In some non-limiting embodiments of the present disclosure, the reduction process includes crushing the alloy powder obtained by the internal oxidation and then conducting the reduction.

In some non-limiting embodiments of the present disclosure, the reduction process is conducted by hydrogen reduction at 800° C. to 900° C. for 2 hours to 8 hours.

In some non-limiting embodiments of the present disclosure, the hot extrusion is conducted at a temperature ranging from 880° C. to 920° C. and at an extrusion ratio no less than 8:1; optionally, the hot extrusion is conducted at a temperature ranging from 900° C. to 920° C.

In some non-limiting embodiments of the present disclosure, the solid solution treatment is conducted at a temperature ranging from 920° C. to 1050° C. for 2 hour to 8 hours, and water-quenching is conducted after the solid solution treatment.

In some non-limiting embodiments of the present disclosure, the cold deformation is conducted to a ratio ranging from 60% to 85%.

In some non-limiting embodiments of the present disclosure, the cold deformation includes cold forging or cold drawing; and optionally, the cold forging is rotary forging.

In some non-limiting embodiments of the present disclosure, the aging treatment is conducted at a temperature of 400° C. to 500° C. for 1 hour to 10 hours.

In some non-limiting embodiments of the present disclosure, the composite powder contains Al₂O₃ in the range of 0.27 vol % to 4.5 vol % and Cr in the range of 0.05 wt % to 5 wt %.

According to another non-limiting aspect of the present disclosure, there is provided nanoparticle dispersion strengthened copper alloy manufactured by the above method.

According to the copper alloy of a non-limiting embodiment of the present disclosure, at least the following beneficial effects are achieved. The copper alloy according to the technical scheme of the present disclosure has low aluminum residue, high electrical conductivity and elongation. Compared to conventional copper alloys, the electrical conductivity is increased by 3% to 20% IACS, and the alloy is easier to process.

According to yet another non-limiting aspect of the present disclosure, there is provided use of the nanoparticle dispersion strengthened copper alloy described above in the field of computers, communications and consumer electronics (3C), information technology (IT), artificial intelligence (AI), new energy vehicles, ultra-high voltage power transmission and transformation, aerospace, or high-speed rail transportation.

According to the use of a non-limiting embodiment of the present disclosure, at least the following beneficial effects are achieved. The copper alloy prepared according to the present disclosure exhibits high strength and high heat resistance, while also being readily machinable, possessing broad application prospects in various fields, such as 3C, IT, AI, new energy vehicles, ultra-high voltage transmission and transformation, aerospace, and high-speed rail transportation.

### BRIEF DESCRIPTION OF DRAWINGS

The present disclosure will be further illustrated with reference to the accompanying drawings and examples. In the accompanying drawing:

FIG. 1 shows an EDS elemental line scan of the hot-pressed Cu—Al₂O₃—Cr alloy at Cr particles in Example 1 of the present disclosure.

### DETAILED DESCRIPTION

The concept and technical effects of the present disclosure will be clearly and comprehensively presented through the following examples, facilitating a thorough understanding of the purpose, features, and effects of the present disclosure. Obviously, the described examples are only part of the examples of the present disclosure, not all of them. Based on the examples of the present disclosure, all other examples obtained by those skilled in the art without involving inventive effort are within the scope of protection of the present disclosure. Unless otherwise specified, the methods used in the experiments in the examples are conventional methods; and the materials and reagents used, unless otherwise specified, are commercially available reagents and materials.

### Example 1

In this example, a nanoparticle dispersion strengthened copper alloy was prepared, and the specific process was as follows.

A Cu—Al alloy with 0.6 wt % Al content was melted at 1210° C. High-purity nitrogen gas atomization was used to prepare alloy powder, which was then sieved to obtain alloy powder with particles smaller than 40 mesh. The resulting alloy powder was then mixed with Cu₂O (7.15% by weight relative to the original Cu—Al powder) to form a mixed powder. The mixed powder was then subjected to internal oxidation at 900° C. for 6 hours. The internally oxidized powder was crushed and then reduced in hydrogen gas at 800° C. for 6 hours to prepare Cu-2.7 vol. % (1.1 wt %) Al₂O₃ dispersed copper powder. This dispersed copper powder was mixed with Cr powder (less than 200 mesh, 1% by weight of the total powder mixture). The mixture was cold isostatic pressed, and then vacuum hot-press sintered at a temperature of 1070° C. and a pressure of 50 MPa for a duration of 4 hours. The sintered compact was sheathed in pure copper in an argon atmosphere and hot extruded into a rod at 910° C. using a water-sealed process, with an extrusion ratio of 10:1. The extruded rod was then water quenched. The water-quenched rod was solid solution treated at 920° C. for 3 hours and then water-quenched; and then cold rotary forged with an 80% deformation. Finally, the forged rod was aged at 450° C. for 6 hours.

### Example 2

In this example, a nanoparticle dispersion strengthened copper alloy was prepared, and the specific process was as follows.

A Cu—Al alloy with 0.6 wt % Al content was melted at 1210° C. High-purity nitrogen gas atomization was used to prepare alloy powder, which was then sieved to obtain alloy powder with particles smaller than 40 mesh. The resulting alloy powder was then mixed with Cu₂O (7.15% by weight relative to the original Cu—Al powder) to form a mixed powder. The mixed powder was then subjected to internal oxidation at 900° C. for 6 hours. The internally oxidized powder was crushed and then reduced in hydrogen gas at 800° C. for 6 hours to prepare Cu-2.7 vol. % Al₂O₃ dispersed copper powder. This dispersed copper powder was mixed with Cr powder (less than 200 mesh, 0.5% by weight of the total powder mixture). The mixture was cold isostatic pressed, and then vacuum hot-press sintered at a temperature of 1060° C. and a pressure of 70 MPa for a duration of 4 hours. The sintered compact was sheathed in pure copper in an argon atmosphere and hot extruded into a rod at 910° C. using a water-sealed process, with an extrusion ratio of 10:1. The extruded rod was then water quenched. The water-quenched rod was solid solution treated at 920° C. for 3 hours and then water-quenched; and then cold rotary forged with an 80% deformation. Finally, the forged rod was aged at 450° C. for 4 hours.

### Example 3

In this example, a nanoparticle dispersion strengthened copper alloy was prepared, and the specific process was as follows.

A Cu—Al alloy with 0.6 wt % Al content was melted at 1210° C. High-purity nitrogen gas atomization was used to prepare alloy powder, which was then sieved to obtain alloy powder with particles smaller than 40 mesh. The resulting alloy powder was then mixed with Cu₂O (7.15% by weight relative to the original Cu—Al powder) to form a mixed powder. The mixed powder was then subjected to internal oxidation at 900° C. for 6 hours. The internally oxidized powder was crushed and then reduced in hydrogen gas at 800° C. for 6 hours to prepare Cu-2.7 vol. % Al₂O₃ dispersed copper powder. This dispersed copper powder was mixed with Cr powder (less than 200 mesh, 0.25% by weight of the total powder mixture). The mixture was cold isostatic pressed, and then vacuum hot-press sintered at a temperature of 1060° C. and a pressure of 70 MPa for a duration of 4 hours. The sintered compact was sheathed in pure copper in an argon atmosphere and hot extruded into a rod at 910° C. using a water-sealed process, with an extrusion ratio of 10:1. The extruded rod was then water quenched. The water-quenched rod was solid solution treated at 920° C. for 3 hours and then water-quenched; and then cold rotary forged with an 80% deformation. Finally, the forged rod was aged at 450° C. for 4 hours.

### Example 4

In this example, a nanoparticle dispersion strengthened copper alloy was prepared, and the specific process was as follows.

A Cu—Al alloy with 0.25 wt % Al content was melted at 1210° C. High-purity nitrogen gas atomization was used to prepare alloy powder, which was then sieved to obtain alloy powder with particles smaller than 40 mesh. The resulting alloy powder was then mixed with Cu₂O (3.18% by weight relative to the original Cu—Al powder) to form a mixed powder. The mixed powder was then subjected to internal oxidation at 900° C. for 6 hours. The internally oxidized powder was crushed and then reduced in hydrogen gas at 800° C. for 6 hours to prepare Cu-1.12 vol. % Al₂O₃ dispersed copper powder. This dispersed copper powder was mixed with Cr powder (less than 200 mesh, 0.05% by weight of the total powder mixture). The mixture was cold isostatic pressed, and then vacuum hot-press sintered at a temperature of 1060° C. and a pressure of 70 MPa for a duration of 4 hours. The sintered compact was sheathed in pure copper in an argon atmosphere and hot extruded into a rod at 910° C. using a water-sealed process, with an extrusion ratio of 10:1. The extruded rod was then water quenched. The water-quenched rod was solid solution treated at 900° C. for 2 hours and then water-quenched; and then cold rotary forged with an 80% deformation. Finally, the forged rod was aged at 450° C. for 4 hours.

### Example 5

In this example, a nanoparticle dispersion strengthened copper alloy was prepared, and the specific process was as follows.

A Cu—Al alloy with 1 wt % Al content was melted at 1210° C. High-purity nitrogen gas atomization was used to prepare alloy powder, which was then sieved to obtain alloy powder with particles smaller than 40 mesh. The resulting alloy powder was then mixed with Cu₂O (10.33% by weight relative to the original Cu—Al powder) to form a mixed powder. The mixed powder was then subjected to internal oxidation at 900° C. for 6 hours. The internally oxidized powder was crushed and then reduced in hydrogen gas at 800° C. for 6 hours to prepare Cu-4.5 vol. % Al₂O₃ dispersed copper powder. This dispersed copper powder was mixed with Cr powder (less than 200 mesh, 5% by weight of the total powder mixture in the composite powder). The mixture was cold isostatic pressed, and then vacuum hot-press sintered at a temperature of 1060° C. and a pressure of 70 MPa for a duration of 4 hours. The sintered compact was sheathed in pure copper in an argon atmosphere and hot extruded into a rod at 910° C. using a water-sealed process, with an extrusion ratio of 10:1. The extruded rod was then water quenched. The water-quenched rod was solid solution treated at 980° C. for 3 hours and then water-quenched; and then cold rotary forged with an 60% deformation. Finally, the forged rod was aged at 450° C. for 6 hours.

### Comparative Example 1

A copper alloy was prepared in this comparative example, which differs from Example 1 only in the absence of Cr powder.

### Comparative Example 2

A copper alloy was prepared in this comparative example, which differs from Example 2 only in the absence of Cr powder.

### Comparative Example 3

A copper alloy was prepared in this comparative example, which differs from Example 3 only in the absence of Cr powder.

### Comparative Example 4

A copper alloy was prepared in this comparative example, which differs from Example 4 only in the absence of Cr powder.

### Comparative Example 5

A copper alloy was prepared in this comparative example, which differs from Example 5 only in the absence of Cr powder.

### Test Examples

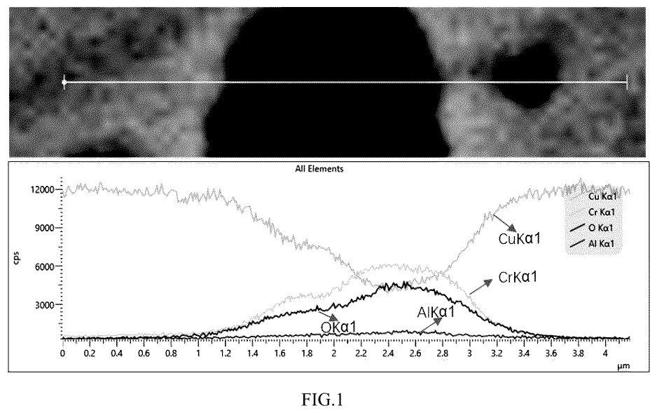

An EDS elemental line scan of the hot-pressed alloy (Cu—Al₂O₃—Cr) at Cr particles in Example 1 of the present disclosure is shown in FIG. 1. As observed in the figure, the Al content at the Cr particles is slightly higher than in the matrix. The test results of Examples 2 to 5 are similar and are not shown individually to avoid redundancy.

The properties (hardness, yield strength, elongation, and electrical conductivity) of copper alloys prepared in Examples 1 to 5 and Comparative examples 1 to 5 were tested, and the results are shown in Tables 1 to 5 below, respectively.

TABLE 1

| | | | | Electrical |
|---|---|---|---|---|
| | HV | Yield strength | Elongation A | conductivity |
| Sample | value | (MPa) | (%) | (% IACS) |
| Comparative | 168 | 578 | 6 | 78.5 |
| example 1 | | | | |
| Example 1 | 172 | 585 | 14.5 | 86.7 |

TABLE 2

| | | | | Electrical |
|---|---|---|---|---|
| | HV | Yield strength | Elongation A | conductivity |
| Sample | value | (MPa) | (%) | (% IACS) |
| Comparative | 166 | 572 | 7.2 | 78.2 |
| example 2 | | | | |
| Example 2 | 171 | 587 | 11.6 | 87.8 |

TABLE 3

| | | | | Electrical |
|---|---|---|---|---|
| | HV | Yield strength | Elongation A | conductivity |
| Sample | value | (MPa) | (%) | (% IACS) |
| Comparative | 165 | 575 | 7.2 | 78.2 |
| example 3 | | | | |
| Example 3 | 168 | 581 | 9.5 | 90.5 |

TABLE 4

| | | | | Electrical |
|---|---|---|---|---|
| | HV | Yield strength | Elongation A | conductivity |
| Sample | value | (MPa) | (%) | (% IACS) |
| Comparative | 132 | 460 | 9.5 | 86 |
| example 4 | | | | |
| Example 4 | 130 | 466 | 14.2 | 94.3 |

TABLE 5

| | | | | Electrical |
|---|---|---|---|---|
| | HV | Yield strength | Elongation A | conductivity |
| Sample | value | (MPa) | (%) | (% IACS) |
| Comparative | 163 | 580 | 4 | 72.5 |
| example 5 | | | | |
| Example 5 | 164 | 583 | 8 | 84.5 |

As shown in the tables above, the copper alloys prepared according to the technical schemes of the present disclosure exhibit higher hardness, higher yield strength, and significantly improved elongation and electrical conductivity. According to the technical schemes of the examples of the present disclosure, mixing the Cu—Al₂O₃ dispersed copper powder with Cr powder and subjecting the mixture to high-temperature sintering promotes the formation of a solid solution between the residual Al in the dispersed copper matrix and Cr, and subsequent aging treatment allows for the complete precipitation of this solid solution from the matrix, effectively reducing the residual Al concentration in the dispersed copper. This significantly improves the electrical conductivity of the dispersed copper alloy. Furthermore, the solid solution treatment and aging treatment significantly enhance the plasticity of the dispersed copper, making it more readily machinable. Compared to dispersed copper without added Cr powder, the material prepared according to the technical scheme of the present disclosure demonstrates a significant enhancement in both electrical conductivity and elongation. By means of the in-situ preparation technique according to the present disclosure, the resulted copper alloy with high strength, high electrical conductivity and high heat resistance overcomes the problem that the electrical conductivity and plasticity of traditional dispersed copper decrease sharply as the Al₂O₃ concentration increases; and depending on the amount of Cr powder added, the electrical conductivity is improved by 3-20% IACS compared to the alloy without Cr addition. This copper alloy with high strength, high electrical conductivity and high heat resistance would gain wider application in the fields of new energy vehicles, ultra-high voltage power transmission and transformation, aerospace, and high-speed rail transportation.

Although the examples of the present disclosure have been described in detail above with reference to the accompanying drawings, the present disclosure is not limited to the above examples, and various changes may be made within the knowledge of those of ordinary skill in the art without departing from the purpose of the present disclosure. In addition, the examples of the present disclosure and the features in the examples can be combined with each other without conflict.

1-10. (canceled)

11. A method for preparing a nanoparticle dispersion strengthened copper alloy, comprising the steps of:
S1: preparing Cu—Al₂O₃ dispersed copper powder from Cu—Al alloy powder by internal oxidation and reduction; and
S2: mixing the Cu—Al₂O₃ dispersed copper powder prepared in step S1 with Cr powder to obtain a composite powder, and subjecting the composite powder to press forming, hot press sintering, sheath moulding, hot extrusion, solid solution treatment, cold deformation, and then aging treatment;
wherein the hot press sintering is conducted at a temperature within an approximate range of 900° C. to 1070° C. and a pressure within an approximate range of 40 MPa to 80 MPa for a duration within an approximate range of 2 hours to 8 hours.

12. The method for preparing a nanoparticle dispersion strengthened copper alloy according to claim 11, wherein
the main components of the nanoparticle dispersion strengthened copper alloy are copper, Al₂O₃ and Cr, wherein
the nanoparticle dispersion strengthened copper alloy contains Al₂O₃ in a range of 0.23 vol % to 4.5 vol % and Cr in a range of 0.05 wt % to 5 wt %.

13. The method for preparing a nanoparticle dispersion strengthened copper alloy according to claim 11, wherein the internal oxidation includes the steps of:
melting Al and Cu at 1200° C. to 1230° C. to prepare the alloy powder by atomization using a protective gas, and then
mixing the resulting alloy powder with an oxidizing agent for oxidation reaction, wherein the oxidizing agent is at least one of Cu₂O and CuO.

14. The method for preparing a nanoparticle dispersion strengthened copper alloy according to claim 13, wherein a mass ratio of the oxidizing agent to the alloy powder ranges from 0.005:1 to 10:1.

15. The method for preparing a nanoparticle dispersion strengthened copper alloy according to claim 13, wherein the protective gas is nitrogen or inert gas.

16. The method for preparing a nanoparticle dispersion strengthened copper alloy according to claim 13, wherein the internal oxidation further includes the step of sieving the alloy powder obtained by atomization to sieve out the alloy powder with a particle size of less than 40 mesh.

17. The method for preparing a nanoparticle dispersion strengthened copper alloy according to claim 16, wherein the internal oxidation is conducted at a temperature ranging from 880° C. to 920° C. for a duration ranging from 1 hour to 8 hours.

18. The method for preparing a nanoparticle dispersion strengthened copper alloy according to claim 11, wherein the reduction includes crushing the alloy powder obtained by the internal oxidation and then conducting the reduction.

19. The method for preparing a nanoparticle dispersion strengthened copper alloy according to claim 18, wherein the reduction is conducted by hydrogen reduction at 800° C. to 900° C. for 2 hours to 8 hours.

20. The method for preparing a nanoparticle dispersion strengthened copper alloy according to claim 11, wherein the hot extrusion is conducted at a temperature ranging from 880° C. to 920° C. and at an extrusion ratio no less than 8:1.

21. The method for preparing a nanoparticle dispersion strengthened copper alloy according to claim 11, wherein the aging treatment is conducted at a temperature within an approximate range of 400° C. to 500° C. for a duration within an approximate range of 1 hour to 10 hours.

22. The method for preparing a nanoparticle dispersion strengthened copper alloy according to claim 11, wherein the composite powder contains Al₂O₃ in a range of 0.27 vol % to 4.5 vol % and Cr in a range of 0.05 wt % to 5 wt %.

23. The method for preparing a nanoparticle dispersion strengthened copper alloy according to claim 13, wherein the oxidizing agent and the alloy powder are mixed at a ratio where the ratio of the oxygen in the oxidizing agent to the aluminum in the powder, O:Al, ranges from 0.9:1 to 1.8:1.

24. The method for preparing a nanoparticle dispersion strengthened copper alloy according to claim 11, wherein the hot extrusion is conducted at a temperature ranging from 900° C. to 920° C.

25. The method for preparing a nanoparticle dispersion strengthened copper alloy according to claim 11, wherein the solid solution treatment is conducted at a temperature ranging from 920° C. to 1050° C. for a duration ranging from 2 hours to 8 hours, and water-quenching is conducted after the solid solution treatment.

26. The method for preparing a nanoparticle dispersion strengthened copper alloy according to claim 11, wherein the cold deformation is conducted to a ratio ranging from 60% to 85%.

27. The method for preparing a nanoparticle dispersion strengthened copper alloy according to claim 11, wherein the cold deformation includes cold forging or cold drawing.

28. The method for preparing a nanoparticle dispersion strengthened copper alloy according to claim 27, wherein the cold forging is rotary forging.

29. A nanoparticle dispersion strengthened copper alloy prepared according to the method of claim 11.
